(19) United States
(12) Patent Application Publication
(10) Pub. No.: US 2018/0062476 A1
(43) Pub. Date: Mar. 1, 2018

(54) MOTOR AND MOTOR ASSEMBLY DEVICE

(71) Applicant: MABUCHI MOTOR CO., LTD., Matsudo City (JP)

(72) Inventors: Satoshi IZUKA, Matsudo City (JP); Satoshi SHIMIZU, Matsudo City (JP)

(73) Assignee: MABUCHI MOTOR CO., LTD., Matsudo City (JP)

(21) Appl. No.: 15/685,948

(22) Filed: Aug. 24, 2017

(30) Foreign Application Priority Data
Aug. 29, 2016 (JP) 2016-167367
Mar. 30, 2017 (JP) 2017-069222

(51) Int. Cl. H02K 5/15; H02K 5/22; H02K 5/16

(52) U.S. Cl. CPC H02K 5/15; H02K 5/16; H02K 5/225

(57) ABSTRACT

A motor addresses the problem of a decrease in usability due to the use of a complex structure on a counterpart mechanism on which the motor is mounted, the complex structure being used to prevent rotation of the motor on the counterpart mechanism while centering the motor shaft. The motor includes: a rotor with a shaft; a housing covering an outer periphery of the rotor; and an end plate covering an end portion of the housing in an axial direction of the rotor. The end plate includes a protruding portion for enabling external contact protruding in a direction in which the shaft extends. The protruding portion has an outer peripheral surface having a non-circular shape in a cross section perpendicular to the direction in which the shaft extends, and has an opening through a face thereof opposing the shaft.

### BACKGROUND

### 1. Technical Field

The present invention relates to a motor and a motor assembly device.

### 2. Related Art

Miniature motors are conventionally used as a drive source for various devices. For example, a miniature motor is used in electrical equipment, such as an automotive power window.

When a motor is mounted to another member such as a gear box, the motor may be adapted to be mounted in any of a plurality of rotational positions about the shaft (see JP-A-2003-52144 and DE 20 2008 005 744 U1, for example).

### SUMMARY

However, in JP-A-2003-52144, in order to prevent rotation of the motor on the gear box while centering the motor shaft with respect to the gear box, a complex structure needs to be used on the gear box side, thus detracting from usability. Similarly, in DE 20 2008 005 744 U1, the case to which the motor is to be mounted is provided with a plurality of holes for inserting protrusions on an axial end face of the motor, requiring the use of a complex structure on the case side.

The present invention was made in view of the above circumstances, and an object of the present invention is to prevent a motor from rotating with respect to a counterpart member for mounting, using a simple configuration.

According to a first embodiment of the present invention, a motor includes a rotor including a shaft; a housing covering an outer periphery of the rotor; and an end plate covering an end portion of the housing in an axial direction of the rotor. The end plate includes a protruding portion protruding in a direction in which the shaft extends for enabling external contact. The protruding portion has an outer peripheral surface having a non-circular shape in a cross section perpendicular to the direction in which the shaft extends. The protruding portion includes an opening through a face thereof opposing the shaft. In this way, when the motor is mounted to another member, rotation of the motor can be prevented against the rotational torque of the motor by a simple configuration of a flat face contacted with the other member.

The protruding portion may include a plurality of flat faces parallel with the shaft. The plurality of flat faces may be provided rotationally symmetrically with respect to a center of the shaft and exposed for enabling external contact. In this way, a simple protruding portion configuration can be obtained.

The plurality of flat faces may include three or more faces forming the sides of a regular polygon. In this way, a simple configuration of the flat portion for rotation prevention can be obtained.

The non-circular shape may be rotationally symmetric with respect to a predetermined angle. In this way, the freedom of design of the manner of mounting of the motor can be increased.

The end plate may further include a circular engaging portion concentric with the center of the shaft. In this way, accurate centering can be achieved using the circular engaging portion.

The circular engaging portion may have a recessed shape and be provided inwardly of the protruding portion. In this way, the counterpart member having a protruding shape with respect to which centering is to be performed can be handled.

The protruding portion may have a distance between the outer peripheral surface and the shaft which is smaller than a distance between the housing and the shaft. In this way, an overall size reduction can be achieved without increasing the radial length of the motor.

The protruding portion may include a bearing which supports the shaft. In this way, an overall size reduction can be achieved without increasing the axial length of the motor.

The end plate and the protruding portion may be integrally molded from a same member. In this way, the flat portion can be formed by simple processing, such as press working.

The housing and the end plate may be integrally molded from a same member.

In this way, the end plate and the flat portion can be formed by simple processing, such as press working.

The housing may hold the end plate. In this way, the end plate can be formed from a separate member from the housing.

According to a second embodiment of the present invention, a motor assembly device includes any of the above motors; a device body in which the motor is assembled; and a rotation regulating portion which is linked with the device body, and which is abutted on at least a part of the non-circular shape of the protruding portion so as to regulate rotation of the motor about the shaft. The non-circular shape portion of the motor and the rotation regulating portion are abutted on each other, whereby rotation on the motor assembly device can be easily regulated against the rotational torque of the motor.

The above Summary is not an exhaustive list of the features of the present invention. The present invention may include sub-combinations of the listed features.

### BRIEF DESCRIPTION OF DRAWINGS

FIG. 1 is a side view of a motor 10 according to an embodiment;

FIG. 2 is a front view of the motor 10;

FIG. 3 is a rear view of the motor 10;

FIG. 4 is a cross sectional view of the motor 10;

FIG. 5 is a side view of a motor 12;

FIG. 6 is a front view of the motor 12;

FIG. 7 is a rear view of the motor 12;

FIG. 8 is a rear view of an end plate 72;

FIG. 9 is a side view of the end plate 72;

FIG. 10 is a cross sectional view of the end plate 72;

FIG. 11 is a schematic cross sectional view of another example regarding a bearing;

FIG. 12 is a perspective view of a bearing holding portion 100;

FIG. 13 is a perspective view of the bearing holding portion 100;

FIG. 14 is a perspective view of a power seat slide device 200;

FIG. 15 is a schematic plan view of an example of an assembly device 120 in which the motor 10 is assembled;

FIG. 16 is a front view of the motor 10 of FIG. 15 as viewed from the side of a protruding portion 62;

FIG. 17 is a schematic perspective view of an example of another assembly device 150; and

FIG. 18 is a front view of the motor 10 of FIG. 17 as viewed from the side of the protruding portion 62.

### DETAILED DESCRIPTION

In the following, the present invention will be described with reference to embodiments of the invention. The embodiments, however, are not intended to limit the invention set forth in the claims. Not all of the combinations of the features described in the embodiments are necessarily required by the solutions provided by the invention.

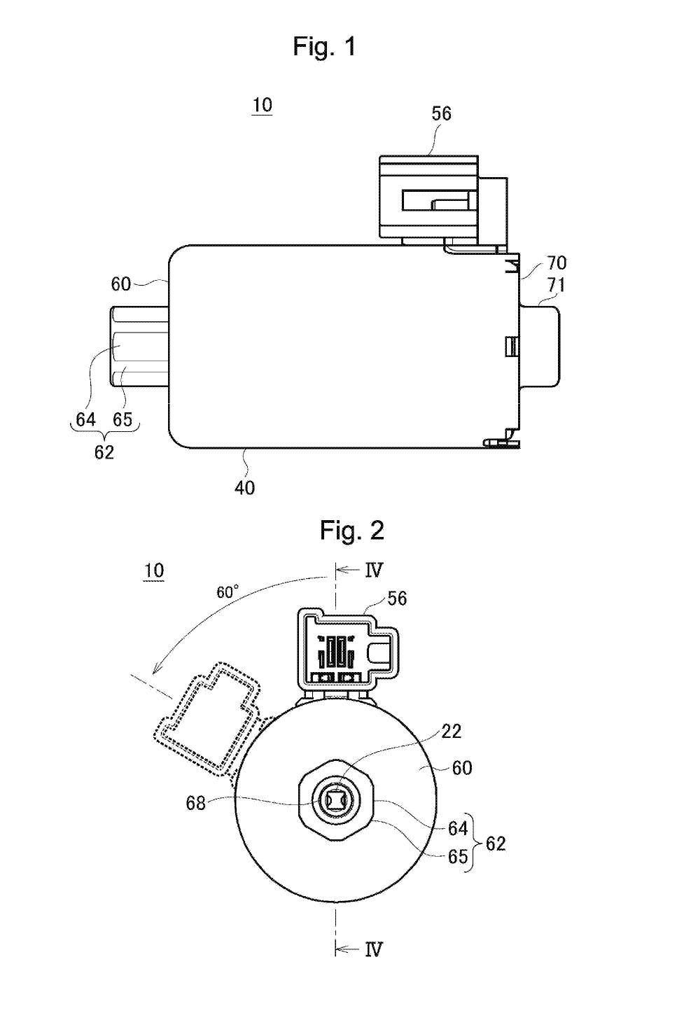

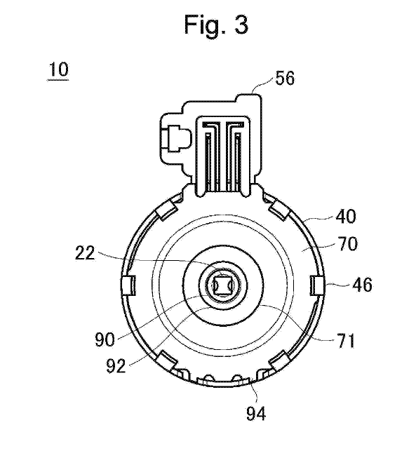

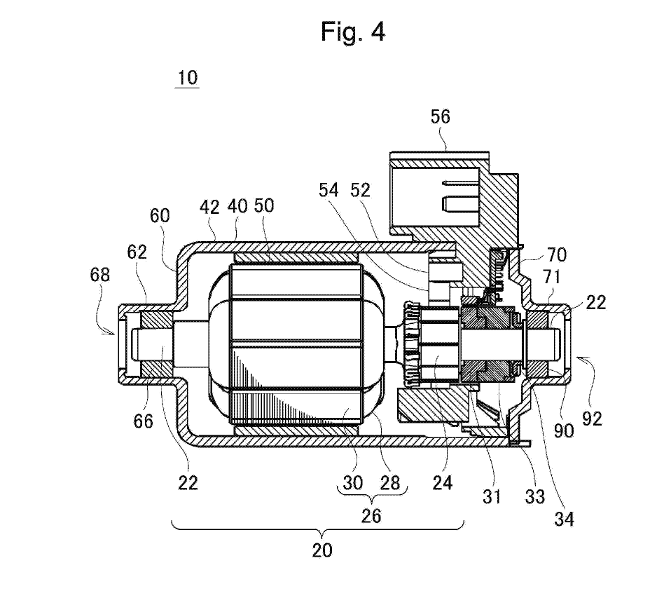

FIG. 1 is a side view of a motor 10 according to the present embodiment. FIG. 2 is a front view of the motor 10. FIG. 3 is a rear view of the motor 10. FIG. 4 is a cross sectional view of the motor 10.

The motor 10 illustrated in FIG. 1 to FIG. 4 outputs a rotational driving force based on a current supplied from an external power supply. The motor 10 is a DC motor, for example, and used in an automobile power window or power seat, for example. The motor 10 includes a housing 40, a connector 56 assembled in the housing 40, and an end plate 70 held on the housing 40.

The housing 40 includes a cylindrical portion 42 and an end face 60. The housing 40 is made of, e.g., metal, and integrally formed by press working, for example. As illustrated in FIG. 4, a magnet 50 is disposed on the inner periphery of the housing 40. The housing 40 accommodates a rotor 20. In other words, the housing 40 covers the outer periphery of the rotor 20.

The rotor 20 includes a shaft 22, a commutator 24 mounted to the shaft 22, and an armature 26. The armature 26 includes a core 30 and a winding 28 wound on the core 30.

To the shaft 22, there are further mounted a detection magnet 31 used for detecting the rotational position of the rotor 20; a bushing 33 for holding the detection magnet 31; and a spring 34 for absorbing axial play of the rotor 20. The detection magnet 31, the bushing 33, and the spring 34 integrally rotate with the shaft 22.

The connector 56 is linked with a brush holder 52 that holds a carbon brush 54. The carbon brush 54 contacts the commutator 24. Accordingly, an electric signal inputted from the connector 56 flows in a corresponding winding 28 via the carbon brush 54 and the commutator 24. As a result, the rotor 20 rotates and rotational driving force is supplied from the shaft 22 to the outside. The connector 56 and the brush holder 52 are made of insulating resin, for example, and include wiring for the electric signal.

The end plate 70 is mounted to the opposite side of the housing 40 from the end face 60. In other words, the end plate 70 covers an end portion of the housing 40 in the axial direction of the rotor 20. The end plate 70 is made of metal and formed by press working, for example. The end plate 70 and the housing 40 are respectively provided with nails 94, 46. The nails 94 integrally formed with the end plate 70 are positioned by being engaged with the end portion of the housing 40. The nails 46 integrally formed with the housing 40 are bent so as to fix and hold the end plate 70 to the housing 40. The nails 46 may be provided so as to project from the end portion of the housing 40 in the motor axis direction. The nails 46 may also be formed by cutting and bending the end portion of the housing 40.

The end plate 70 is substantially circular and provided with a protruding portion 71 at the center. The protruding portion 71 protrudes in a direction away from the rotor 20 in the axial direction of the shaft 22, and has a cylindrical shape concentric with the shaft 22. Accordingly, the protruding portion 71, when viewed from the rear side, has a circular outer shape, as illustrated in FIG. 3. The protruding portion 71 has a bearing 90 accommodated therein. The bearing 90 has an inner periphery which is cylindrical or substantially cylindrical having a recess/projection in a part thereof with a different diameter. Into the bearing 90, one end of the shaft 22 in the axial direction is inserted, whereby the one end is supported. The outer periphery of the bearing 90 has a shape corresponding to the inner periphery of the protruding portion 71. In the example of FIG. 2, in correspondence to the substantially cylindrical shape of the inner periphery of the protruding portion 71, the outer periphery of the bearing 90 is also substantially columnar. The outer periphery of the bearing 90 may be spherical. At the center of the distal end of the protruding portion 71, an opening 92 is provided, so that the power of the shaft 22 can be transmitted to the outside via the opening 92.

The housing 40 includes a protruding portion 62 protruding from an end face 60 on the front side, i.e., on the left side in FIG. 1. The protruding portion 62, when viewed from the front side, has a rounded regular hexagonal outer shape, as illustrated in FIG. 2. That is, the protruding portion 62 has a cross section perpendicular to the axial direction which includes three sets of mutually parallel flat faces 64, and six curved surfaces 65 linking adjacent flat faces 64. Each of the flat faces 64 is parallel to the axial direction of the shaft 22.

The end face 60 and the protruding portion 62 are parts of the housing 40, and integrally processed during press working of the housing 40. Accordingly, the end face 60 and the protruding portion 62 may be considered an example of an end plate integrally formed of the same member as the housing 40.

The flat faces 64 are exposed so that another member can contact therewith when mounted. In other words, around the flat faces 64, no other members of the motor 10 are extending or otherwise present. In the example of FIG. 2, one of the curved surfaces 65 of the protruding portion 62 is disposed at the position proximate to the connector 56. Alternatively, in a 30° phase shift, one of the flat faces 64 of the protruding portion 62 may be disposed at the position proximate to the connector 56.

The protruding portion 62 has a bearing 66 accommodated therein. The bearing 66 has an inner periphery which has a cylindrical shape or a substantially cylindrical shape having a recess/projection in a part thereof with a different diameter. In the bearing 66, one end of the shaft 22 in the axial direction is inserted, the bearing 66 thus supporting the one end. The bearing 66 has a cylindrical outer periphery internally contacting the inner periphery of the protruding portion 62. The outer periphery of the bearing 66 may be a spherical surface internally contacting the inner periphery of the protruding portion 62. At the center of the distal end of the protruding portion 62, an opening 68 is provided, so that the power of the shaft 22 can be transmitted to the outside via the opening 68.

In the above configuration, when the motor 10 is mounted to another member, the flat faces 64 are placed in face contact with the other member. In this way, against a rotational torque, acting as a reactive force to the rotational driving force of the motor 10, that would rotate the motor 10 itself, the rotation of the motor 10 itself can be stopped by the contacting surfaces of the flat faces 64 and the other member. In particular, when the mutually parallel flat faces 64 are sandwiched by the other member using a structure such as a U-shaped groove, the motor 10 can be reliably held with a simple structure. In addition, because the flat faces 64 are in face contact with the other member, the flat faces 64 and the other member are not readily deformed even when large force is applied thereto. The protruding portion 62 is also used for centering the shaft 22 when the motor 10 is mounted.

The contact with the other member is not limited to face contact, and may include line contact or point contact using a protrusion and the like provided on the flat faces 64 or the other member. In the case of line contact or point contact, in order to prevent radial force acting between the protrusions and the contacting other member, the contact may preferably be made at three or more locations, with adjacent contact positions being not spaced apart from each other by 180 degrees or more in the circumferential direction. In this way, rotation of the motor 10 can be stopped while balancing the radial components of the force that acts against the rotational torque causing the motor 10 itself to rotate. In addition, the line contact or point contact using protrusions and the like provides the advantage of not requiring high size accuracy compared with the case of face contact via flat faces. The flat faces 64 may have a portion that is not flat, such as a cut-out for preventing erroneous insertion.

The flat faces 64, as viewed axially, correspond to the respective sides of a regular hexagon, and are therefore rotationally symmetric at 60° with respect to the center of the shaft 22. Accordingly, when the motor 10 is mounted at the protruding portion 62, the motor 10 can be rotated in either direction from the orientation indicated by solid lines in FIG. 2 in 60° increments. For example, in FIG. 2, the broken lines indicate the position of the connector 56 rotated by 60° in anticlockwise direction with respect to the center of the shaft 22, where the outer shapes of the housing 40 and the protruding portion 62 after the 60° rotation are the same as before rotation. The ability to mount at any of the plurality of rotational positions provides increased mounting freedom without modifying the receiving end. For example, even in a narrow area, the motor can be mounted in an orientation without the connector 56 interfering with other members. In addition, because the adjacent flat faces 64 are linked via the curved surfaces 65, stress concentration at edges that would result if the flat faces 64 were to be directly connected can be prevented.

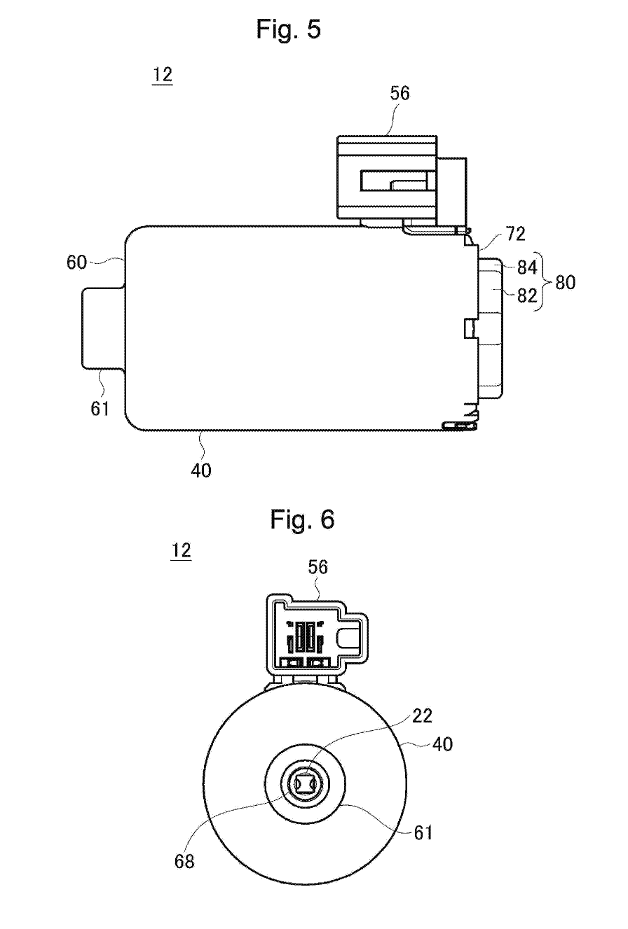

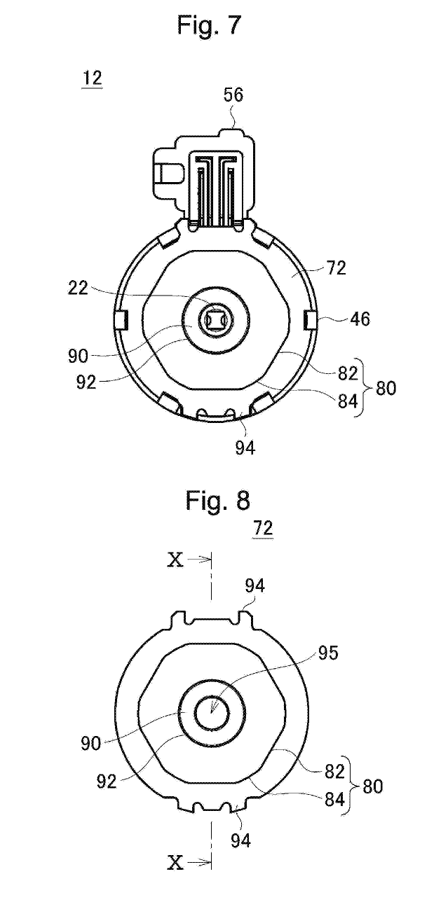

FIG. 5 is a side view of a motor 12 with a different protruding portion. FIG. 6 is a front view of the motor 12. FIG. 7 is a rear view of the motor 12. In the motor 12, elements similar to those of the motor 10 are designated with similar reference numerals and their description is omitted. Similarly, the structures of the motor 12 in the housing 40 and the rotor are similar to those of the motor 10 unless specifically described.

The motor 12 is provided with a protruding portion 80 on the side of an end plate 72, the protruding portion 80 including a flat faces 82 and a curved surfaces 84. On the end face 60 side of the motor 12, a cylindrical protruding portion 61 is provided.

As illustrated in FIG. 7, the flat faces 82 as viewed from the axial direction of the shaft 22 constitute the sides of a regular hexagon. At portions corresponding to the vertexes of the regular hexagon, curved surfaces 84 are provided so as to smoothly link the adjacent flat faces 82. The flat faces 82, similarly to the flat faces 64 of the motor 10, are also exposed so that another member can be contacted therewith when mounted.

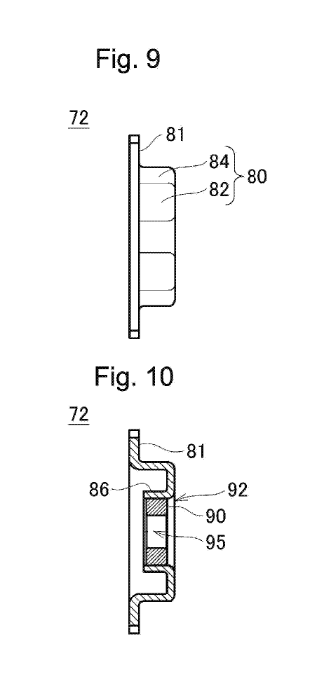

FIG. 8 is a rear view of the end plate 72. FIG. 9 is a side view of the end plate 72. FIG. 10 is a cross sectional view of the end plate 72. The end plate 72 is a separate member from the housing 40, and press-worked. The end plate 70 includes a substantially circular end face 81, with a protruding portion 80 formed at the center. Accordingly, the end plate 72 and the flat faces 82 of the protruding portion 80 are integral molded from the same member. The end plate 72 is fixed and held to the housing 40 by nails 94 of the end plate 72 and the nails 46 of the housing.

The protruding portion 80 is further folded axially inwardly so as to form a recessed circular engaging portion 86. The circular engaging portion 86 has a cross section perpendicular to the axial direction which has a circular inner shape concentric with the shaft 22 to accommodate a bearing 90. The bearing 90 is fixed in the circular portion by press-fitting or swaging, for example. The bearing 90 has an insertion opening 95 for inserting the shaft 22. In the present example, the circular engaging portion 86 is disposed entirely inwardly of the protruding portion 80. Alternatively, a part of the circular engaging portion 86 may extend axially outside the protruding portion 80. The configuration of the bearing 90 may be the same as that of the bearing 90 of the motor 10.

By mounting the protruding portion 80 of the motor 12, similarly to the protruding portion 62 of the motor 10 by sandwiching and holding the mutually parallel flat faces 82, the motor 12 can be reliably held in an anti-rotation manner. In addition, the motor 12 can be mounted in any of the positions rotated by 60° with respect to the center of the shaft 22.

Because the bearing 90 is held in the protruding portion 80, the size of the motor 12 as a whole can be reduced axially without increasing the length of the protruding portion 80 in the axial direction of the shaft 22. Further, because the protruding portion 80 is disposed on the end plate 72 side, the protruding portion 80 can be easily shaped by press-working separately from the housing 40.

The flat faces 82 of the motor 12 have a greater radial distance from the center of the shaft 22 than the flat faces 64 of the motor 10. Accordingly, the rotation of the motor 12 can be stopped more efficiently. In the motor 12, however, the distance from the flat faces 82 to the shaft 22 is shorter than the distance from the housing 40 to the shaft 22. That is, the protruding portion 80 is radially smaller than the housing 40. Accordingly, the radial outer shape of the motor 12 as a whole can be reduced in size. The diameter of the protruding portion 61 having no flat face is smaller than the distance between the mutually facing flat faces 64, further contributing to reduction in size.

The motor 10 has the protruding portion 62 disposed on the left side in side view. The motor 12 has the protruding portions 80 on the right side in side view. In addition, one motor may be provided with the protruding portion 62 on one end and the protruding portion 80 on the other end.

While the circular engaging portions 86 of the motors 12 have a cylindrical inner periphery, the shape of the inner periphery is not limited thereto. For example, the circular engaging portions 86 may have a polygonal-columnar inner periphery with which a cylindrical outer periphery of the bearing 90 can be internally contacted.

The outer peripheries of the protruding portion 62 of the motor 10, the protruding portion 80 of the motors 12, respectively have at least a pair of mutually parallel flat faces. However, the protruding portions may not necessarily have a pair of parallel flat faces. From the viewpoint of regulating rotation against the rotational torque, it may only be required that the protruding portions have a non-circular outer peripheral surface in a cross section perpendicular to the direction in which the shaft 22 extends.

An example of the non-circular shape includes, besides a pair of parallel flat faces, a different curvature in a part of the circumference in a cross section perpendicular to the direction in which the shaft 22 extends. In this case, a part of the circumference may protrude or be recessed. In this way, the rotation can be regulated in a simple structure. A plurality of portions may protrude from the circumference rotationally symmetrically with respect to a predetermined angle, such as 180 degrees, 120 degrees, or 90 degrees, about the shaft 22. Similarly, a plurality of recessed portions may be provided rotationally symmetrically with respect to a predetermined angle, such as 180 degrees, 120 degrees, or 90 degrees, about the shaft 22. By the protruding or recessed portions being rotationally symmetric, the freedom of mounting angle can be increased when the motor is mounted.

Another example of the non-circular shape is a partially linear arc shape. In this case, too, the rotation can be regulated in a simple structure. Other examples of the non-circular shape may include three or more linear portions in addition to the arc and oval shapes.

In any of the above cases, the inner periphery of the protruding portion may have a different shape from the outer periphery. For example, the protruding portion may have a cylindrical inner periphery. In this way, a bearing with a cylindrical or spherical outer periphery can be accommodated. In another example, the protruding portion may have a non-circular inner periphery shape different from the outer periphery.

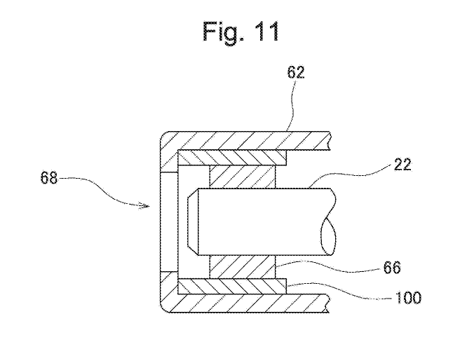

FIG. 11 is a schematic cross sectional view of another example of the bearing. FIG. 11 illustrates another example of the protruding portion 62 side of the motor 10.

In FIG. 11, on the inner periphery of the protruding portion 62, a bearing holding portion 100 is abutted. The bearing 66 is held on the inner periphery of the bearing holding portion 100. The bearing holding portion 100 is made of hard plastic material having elasticity, for example.

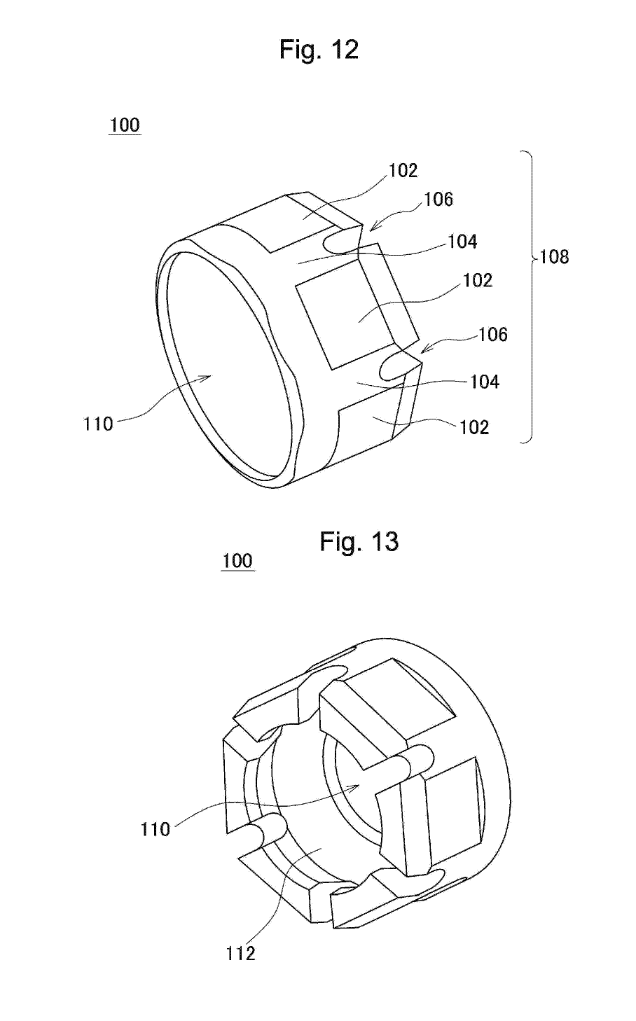

FIG. 12 and FIG. 13 are perspective views of the bearing holding portion 100. The bearing holding portion 100 has an outer periphery 108 with a shape corresponding to the inner periphery of the protruding portion 62. In the example of FIG. 12 and FIG. 13, the inner periphery of the protruding portion 62 has a rounded regular hexagonal-columnar shape, and, correspondingly, the outer periphery 108 of the bearing holding portion 100 has a rounded regular hexagonal-columnar shape. That is, the outer periphery 108 includes six flat faces 102 and curved surfaces 104 linking the same. The curved surfaces 104 include cut-out portions 106. The cut-out portions 106 enable the bearing holding portion 100 to be easily inserted into the protruding portion 62.

The bearing holding portion 100 has an inner periphery 112 with a shape corresponding to the outer periphery of the bearing 66. In the example of FIG. 12 and FIG. 13, the outer periphery of the bearing 66 is cylindrical, and, correspondingly, the inner periphery 112 of the bearing holding portion 100 is also cylindrical. In this way, the bearing 66 can be fixed in the protruding portion 62 while absorbing differences in shape between the inner periphery of the protruding portion 62 and the outer periphery of the bearing 66. Accordingly, the freedom of design of the protruding portion 62 and the bearing 66 can be increased. In addition, because the bearing holding portion 100 has elasticity, the bearing holding portion 100 per se is fixed on the inner periphery of the protruding portion 62, and the bearing holding portion 100 holds and fixes the outer periphery of the bearing 66.

When the outer periphery of the bearing 66 is spherical, the inner periphery 112 of the bearing holding portion 100 may also be spherical. By the outer periphery of the bearing 66 and the inner periphery 112 of the bearing holding portion 100 contacting each other spherically, the shaft 22 can be reliably inserted while absorbing individual differences of the components and permitting rotation of the bearing 66 with respect to the bearing holding portion 100.

The bearing holding portion 100 has an opening 110 provided at the portion opposing the shaft 22. The opening 110 penetrates through the bearing holding portion 100, thereby enabling access to the shaft 22 from the outside via the openings 68, 110.

With reference to FIG. 11 to FIG. 13, an example has been described in which the bearing holding portion 100 is provided on the inner periphery of the protruding portion 62 of the motor 10. The bearing holding portion 100 may be provided at a different location. For example, the bearing holding portion 100 may be provided on the inner periphery of the protruding portion 71 of the motor 10 and the inner periphery of the protruding portion 61 of the motors 12 so as to respectively hold the bearings 66, 90.

The bearing holding portion 100 may also be provided on the inner periphery of the circular engaging portion 86 of the motor 12 so as to hold the bearing 90.

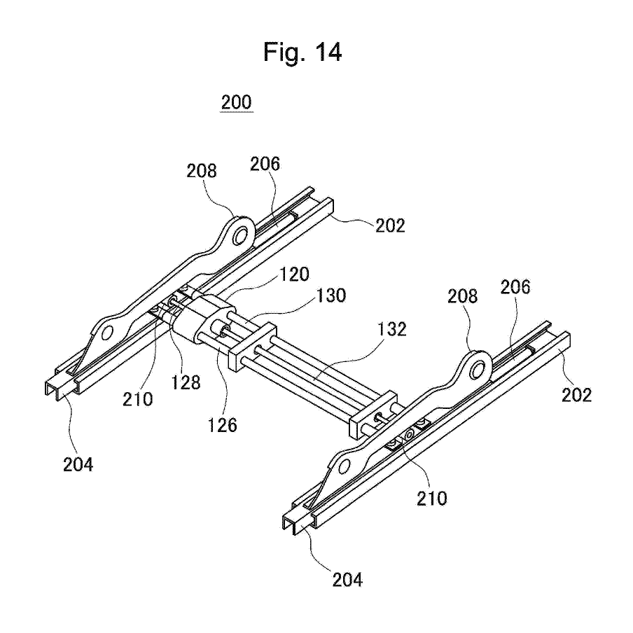

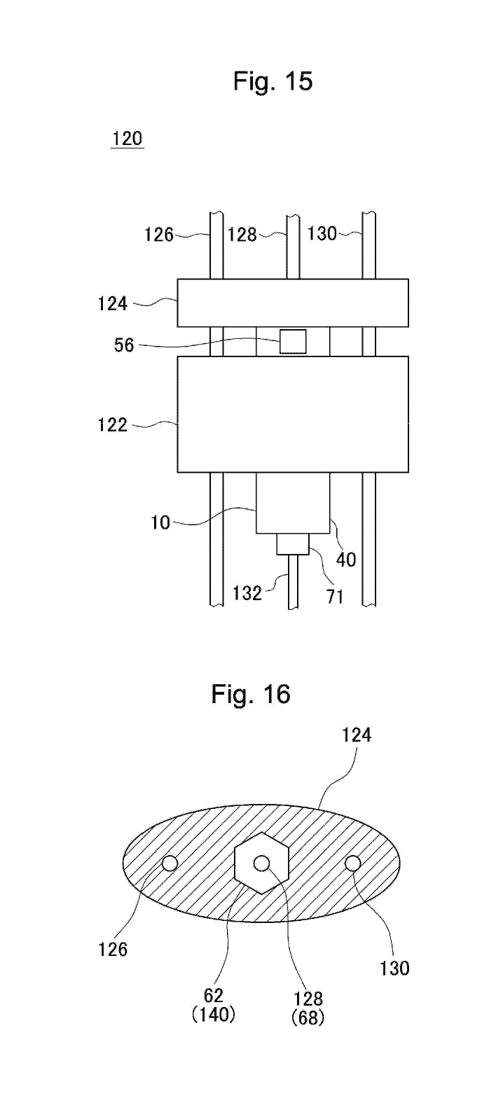

FIG. 14 is a perspective view of a power seat slide device 200. FIG. 15 is a schematic plan view of an assembly device 120 for assembling the motor 10 to the power seat slide device 200.

The power seat slide device 200 includes a pair of lower rails 202 fixed on the floor surface of an automobile; a pair of upper rails 204 slidable on the corresponding lower rails 202; and a pair of cushion frames 208 which are fixed on the pair of upper rails and to which a seat is mounted. Between the pair of upper rails 204, bar-shaped frames 126, 130 are extended.

The assembly device 120 includes a holding member 122 having elasticity, and a rotation regulating portion 124 also having elasticity. The holding member 122 and the rotation regulating portion 124 are made of rubber, for example.

The holding member 122 has a through hole for press-fitting and holding the housing 40 of the motor 10 therein. The holding member 122 also has other through holes through which the frames 126, 130 can be inserted to hold the holding member 122 on the assembly device 120.

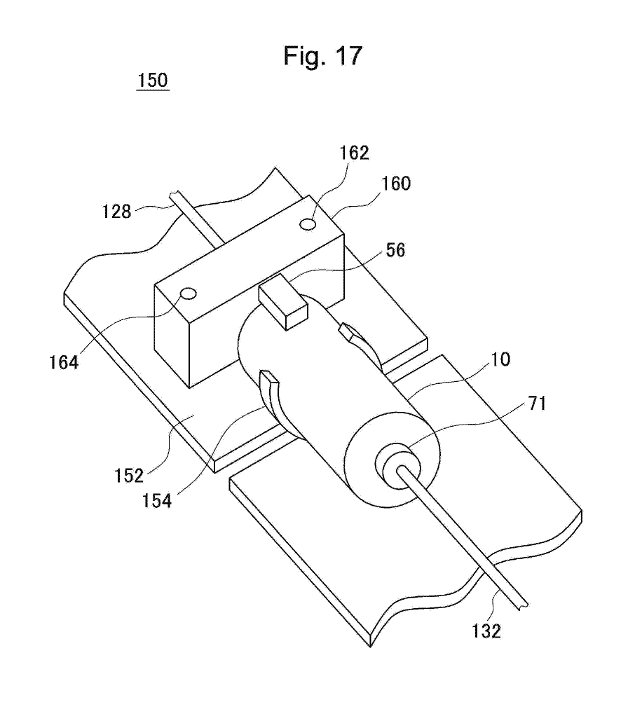

FIG. 16 is a front view of the motor 10 of FIG. 15 as viewed from the side of the protruding portion 62. The rotation regulating portion 124 has a through hole 140. The through hole 140 has an inner periphery which has a non-circular shape corresponding to the outer periphery of the protruding portion 62. In the example of FIG. 16, the outer periphery of the protruding portion 62 is substantially hexagonal-columnar, and, correspondingly, the inner periphery of the through hole 140 is also substantially hexagonal-columnar

The rotation regulating portion 124 includes two through holes into which the frames 126, 130 can be respectively inserted, whereby the rotation regulating portion 124 can be held on the assembly device 120. Herein, by the protruding portion 62 of the motor 10 being inserted into the through hole 140 of the rotation regulating portion 124, the shaft 22 of the motor 10 is positioned with respect to the assembly device 120. Further, the outer periphery of the protruding portion 62 of the motor 10 and the inner periphery of the rotation regulating portion 124 are abutted on each other in a non-circular manner, rotation can be regulated against the rotational torque of the rotation regulating portion 124 that would rotate the motor 10 itself.

Into the opening 68 of the protruding portion 62 of the motor 10, a rotation shaft 128 is inserted. The rotation shaft 128 is linked with the shaft 22 of the motor 10 to transmit the rotational driving force of the shaft 22 to an object to be driven, such as a seat. Similarly, a rotation shaft 132 is linked with the shaft 22 via an opening 92 in the protruding portion 71.

At the ends of the rotation shafts 128, 132, gear mechanisms 210 are provided. The gear mechanisms 210 are respectively meshed with slide screws 206. Accordingly, as the shaft 22 of the motor 10 is rotated, the rotational driving force is transmitted to the gear mechanisms 210 via the rotation shafts 128, 132. As the gear mechanisms 210 are rotated, the gear mechanisms 210 move on the slide screws 206. The movement of the gear mechanisms 210 causes the upper rails 204 and the cushion frames 208 to move, whereby the automobile seat is moved.

According to the embodiment of FIG. 15 and FIG. 16, the non-circular shape portion of the motor 10 and the rotation regulating portion 124 are abutted on each other, whereby rotation in the assembly device 120 can be easily regulated against the rotational torque of the motor 10. In the embodiment of FIG. 15 and FIG. 16, the rotation regulating portion 124 and the holding member 122 are spaced apart from each other. Alternatively, the rotation regulating portion 124 and the holding member 122 may be linked with each other by mating a nail provided on one of the opposing surfaces of the rotation regulating portion 124 and the holding member 122 with a recess portion provided on the other.

FIG. 17 is a schematic perspective view of an example of another assembly device 150. In FIG. 17, elements similar to those of FIG. 15 and FIG. 16 are designated with similar reference numerals and their description is omitted. In the assembly device 150 illustrated in FIG. 17, the motor 10 is held on a substrate 152 which is a part of the body of the assembly device 150. The substrate 152 is a metal plate, for example, and has a pair of fixing nails 154 formed by a part of the substrate 152 cut and raised therefrom. Between the pair of fixing nails 154, the housing 40 of the motor 10 is inserted, and the motor 10 is held by the fixing nails 154.

The assembly device 150 further includes a rotation regulating portion 160. The rotation regulating portion 160 is made of rubber having elasticity, for example. The rotation regulating portion 160 is fixed to the substrate 152 using a pair of screws 162, 164.

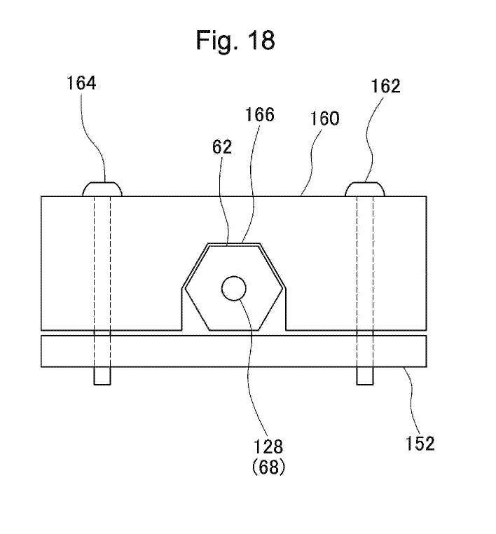

FIG. 18 is a front view of the motor 10 of FIG. 17, as viewed from the side of the protruding portion 62. The rotation regulating portion 160 includes a recess portion 166 cut from below. The recess portion 166 has a shape corresponding to at least the non-circular shape portion of the outer periphery of the protruding portion 62. In the example of FIG. 18, the upper part of the recess portion 166 has the shape of a part of a substantially hexagonal column, in correspondence to the upper half of the protruding portion 62. The lower part of the recess portion 166 has a pair of parallel surfaces that make it easier to sandwich the protruding portion 62 with the substrate 152.

As the protruding portion 62 of the motor 10 is inserted into the recess portion 166 of the rotation regulating portion 160 and sandwiched between the rotation regulating portion 160 and the substrate 152, the shaft 22 of the motor 10 is positioned with respect to the assembly device 150. In addition, the non-circular shape portion of the motor 10 and the rotation regulating portion 160 are abutted on each other, whereby rotation in the assembly device 150 can be easily regulated against the rotational torque of the motor 10.

In the examples of FIG. 15 to FIG. 18, the motor 10 is assembled in the assembly device in a posture such that the connector 56 of the motor 10 is positioned at the top of the housing 40. However, the posture of the motor 10 is not limited to the above posture. Alternatively, the motor 10 may be assembled in the assembly device in a posture such that the connector 56 is positioned laterally of the housing 40, such as directly to the side in FIG. 3. In particular, as long as the connector 56 is disposed within the diameter in the height direction of the housing 40 perpendicular to the axial direction of the shaft 22, the height of the motor 10 as a whole is determined by the diameter of the housing 40 when the connector 56 is assembled to the assembly device in a laterally positioned posture to the housing 40. Accordingly, when the motor 10 is assembled, the height-direction space that would be required for the connector 56 can be saved. This is particularly effective in the case of the power seat slide device, which is spatially restricted in the height direction. In the posture in which the connector 56 is positioned to the side of the housing 40, when the connector 56 includes a surface which is perpendicular to the height direction of the housing 40 and which is parallel with the axial direction of the shaft 22, that surface may also be used for positioning the motor 10 during assembly.

Instead of the examples of FIG. 15 to FIG. 18, the housing 40 of the motor 10 may be held by snap-fitting, or the housing 40 may be provided with a flange for fastening using screws.

In the examples of FIG. 15 to FIG. 18, the rotation regulating portions 124, 160 are rubber members. Instead, the rotation regulating portions may be formed of metal plate material. While an example of assembly of the motor 10 has been described with reference to FIG. 15 to FIG. 18, the motor 12, 14, or 16 may be assembled. In this case, preferably the outer periphery of the protruding portion 80 of the motors 12, 14 and the outer periphery of the protruding portion 78 of the motor 16 are at least partially abutted on the rotation regulating portion so as to regulate rotation.

While the present invention has been described with reference to embodiments, the technical scope of the present invention is not limited to the embodiments. It should be apparent to a person skilled in the art that various modifications or improvements may be made to the embodiments. Embodiments including such modifications or improvements are also included in the technical scope of the present invention, as will be apparent from the claims.

What is claimed is:

1. A motor comprising:
a rotor including a shaft;
a housing covering an outer periphery of the rotor; and
an end plate covering an end portion of the housing in an axial direction of the rotor,
wherein:
the end plate includes a protruding portion protruding in a direction in which the shaft extends for enabling external contact;
the protruding portion has an outer peripheral surface having a non-circular shape in a cross section perpendicular to the direction in which the shaft extends; and
the protruding portion includes an opening through a face thereof opposing the shaft.

2. The motor according to claim 1, wherein:
the protruding portion includes a plurality of flat faces parallel with the shaft; and
the plurality of flat faces are provided rotationally symmetrically with respect to a center of the shaft and exposed for enabling external contact.

3. The motor according to claim 2, wherein the plurality of flat faces comprise three or more faces forming the sides of a regular polygon.

4. The motor according to claim 1, wherein the non-circular shape is rotationally symmetric with respect to a predetermined angle.

5. The motor according to claim 1, wherein the end plate further includes a circular engaging portion concentric with the center of the shaft.

6. The motor according to claim 5, wherein the circular engaging portion has a recessed shape and is provided inwardly of the protruding portion.

7. The motor according to claim 1, wherein the protruding portion has a distance between the outer peripheral surface and the shaft which is smaller than a distance between the housing and the shaft.

8. The motor according to claim 1, wherein the protruding portion further includes a bearing which supports the shaft.

9. The motor according to claim 1, wherein the end plate and the protruding portion are integrally molded from a same member.

10. The motor according to claim 1, wherein the housing and the end plate are integrally molded from a same member.

11. The motor according to claim 1, wherein the housing holds the end plate.

12. A motor assembly device comprising:
the motor according to claim 1;
a device body in which the motor is assembled; and
a rotation regulating portion which is linked with the device body, and which is abutted on at least a part of the non-circular shape of the protruding portion so as to regulate rotation of the motor about the shaft.
